(19) United States
(12) Patent Application Publication
(10) Pub. No.: US 2012/0212442 A1
(43) Pub. Date: Aug. 23, 2012

(54) Device for Transmitting Information to a Living Being

(75) Inventors: Keiji Uchida, Marugame-shi (JP); Hideyuki Sawada, Takamatsu-shi (JP)

(73) Assignees: Kagawa University, Takamatsu-shi (JP); SCA Corporation, Marugame-shi (JP)

(21) Appl. No.: 13/504,087

(22) PCT Filed: Oct. 21, 2010
(86) PCT No.: PCT/JP10/68638

§ 371 Date: Apr. 25, 2012

(30) Foreign Application Priority Data
Oct. 30, 2009 (JP) 2009-251273

(51) Int. Cl. G08B 6/00; G06F 3/041

(52) U.S. Cl. 345/173

(57) ABSTRACT

In a device for transmitting information to a living being, an information related to a display is transmitted to a tactile sense of the living being touching a shape-memory alloy arranged on a display panel, by motion of expansion and contraction of the shape-memory alloy, without obstructing the visibility of the display panel. The device includes a transparent sheet-like tactile perceptual unit, arranged on the display panel, and a signal generating unit, which generates a signal voltage for driving the tactile perceptual unit. The signal generating unit and the display panel are connected to the control unit. The shape-memory alloy attached to the tactile perceptual unit transmits the information to the living being by contracting the shape-memory alloy in response to an application of a signal voltage, with relation to the display of the display panel.

### TECHNICAL FIELD

The present invention relates to a device for transmitting information which transmits information of tactile sense to a living being (body) by use of a shape-memory alloy.

### BACKGROUND ART

Conventionally, a device for transmitting information to (referred to as “information transmitting device”) the tactile sense of a living being by vibration is known, wherein the vibrations are generated by applying pulse voltage to the shape-memory alloy (for example, refer to JP 2007-48268A). Such kind of the information transmitting device has a small size, a lightweight, and a good energy efficiency, so that it can transmit various information to the living being.

In addition, a touch panel is used as an input device attached to a screen of a display device such as a car navigation system. However, the touch panel does not generate a reaction such as a click-like feeling to a fingertip in response to a touch input to the screen by the fingertip, so that it can only be confirmed by visually recognizing a visual change of the screen by the touch input whether the touch input has been done correctly or not. Therefore, there is a problem that a user looks away during a driving of a car or the like.

Thus, it is expected that a response of the touch input is transmitted to the living being such as the fingertip by a vibration of the shape-memory alloy in the device for transmitting information arranged on the screen of the touch panel.

However, when the device is arranged on the screen of the touch panel, there is a problem of obstructing the view of the screen, because a tactile perceptual unit of the device is not transparent, then obstructs a view of the screen. Moreover, the device cannot be arranged on a front surface of an illustration, a display of a screen image, or the like (hereinafter, collectively referred to as a display panel, including the screen of the touch panel).

### PRIOR ART DOCUMENT PATENT DOCUMENT

Patent document 1: JP2007-48268A

### SUMMARY OF THE INVENTION

The present invention solves the above-mentioned problems and an object of the present invention is to provide a device for transmitting information to a living being which can transmit the information related to a touched position or a content displayed on an indicator to the tactile sense of the living being touching the shape-memory alloy which is arranged on the display panel without obstructing the view of the display panel.

To achieve the above objects, the present invention provides;
a device for transmitting information which transmits an information of tactile sense to a living being touching a shape-memory alloy, by motion of expansion and contraction of the shape-memory alloy generated by applying voltage to the shape-memory alloy,
the device includes: a tactile perceptual unit arranged on a display panel which displays visual information, and
a signal generating unit which generates a signal voltage for driving the unit, wherein,
the tactile perceptual unit has a transparent plate arranged on a part of a surface of the display panel and the shape-memory alloy attached to the transparent plate,
the shape-memory alloy, having a thin wire-like form, is in a relaxed state at a time that the signal voltage is not applied and can be touched by the living being, and transmits the information of the tactile sense to the living being touching the shape-memory alloy by contracting the shape-memory alloy in response to an application of the signal voltage from the signal generating unit to the shape-memory alloy, and
the signal generating unit generates the signal voltage related to the displaying image on the display panel.

In the above device, it is preferable that the shape-memory alloy is used for a portion touched by the living being and, in the other portion, a micro wire is substituted for the shape-memory alloy.

In the above device, it is preferable that the transparent plate of the unit for transmitting the tactile sense has a hole at a predetermined position, the shape-memory alloy is arranged so that the shape-memory alloy is suspended across the hole of the transparent plate in the relaxed state, the both ends of the shape-memory alloy are connected to the micro wire, and each micro wire is extended to the both ends of the transparent plate and connected to the signal generating unit at the both ends.

In the above device, it is preferable that the holes of the transparent plate are arranged in series, and the ends of the shape-memory alloy, which is suspended across the hole, are connected to the micro wire, a plural of the shape-memory alloys are connected in series by the micro wire.

In the above device, it is preferable that the tactile perceptual unit has further a transparent protective cover covering both of the shape-memory alloy and the micro wire so as to sandwich the shape-memory alloy and the micro wire between the transparent plate and the transparent protective cover.

In the above device, it is preferable that the transparent protective cover has the hole having the same shape in a position corresponding to the hole of the transparent plate, and the hole exposes the shape-memory alloy.

In the above device, it is preferable that the micro wire is a metal line made of gold, silver, copper, aluminum or tungsten, and each micro wire is connected to the shape-memory alloy by welding at both edges of the hole respectively.

In the above device, it is preferable that the overlap region between the shape-memory alloy and the micro wire, connected by welding, is set within a range from 0.2 mm to 0.4 mm.

In the above device, it is preferable that when the display panel is a touch panel having a touch switch, the signal generating unit drives tactile perceptual unit, in response to an input motion by the living being touching to the tactile perceptual unit which is arranged on the touch switch.

In the above device, it is preferable that a piece of transparent plate with a shape smaller than the hole is fixed to a part of the shape-memory alloy suspended across the hole of the transparent plate.

### EFFECT OF THE INVENTION

According to the present invention, the device can transmit the information of tactile sense related to a content of the display to the living being touching the shape-memory alloy of the unit for transmitting the tactile sense arranged on the display panel, without obstructing the view of the display panel.

Therefore, in case that the display panel is, for example, a graphic display device, the device can transmit the information of the tactile sense of an object displayed on the screen. In addition, in case that the display panel is an illustration display device, the device can transmit the information of the illustration.

According to a modified embodiment of the present invention, the micro wire promotes easily reduction of a drive voltage, because the resistance of the micro wire is generally lower than that of the shape-memory alloy. Therefore, the device can be easily manufactured, and the energy saving is promoted.

Pressing down any one of touch switches of the touch panel generates a transmittance of the information of the tactile sense to the living being, because the same pulse voltage is applied to the shape-memory alloys connected in series. Therefore, the tactile perceptual unit can be configured to have a quite simple structure.

The resistance of the micro wire is lower than that of the shape-memory alloy, so that even in case that the shape-memory alloy is connected in series with the micro wire, a reduction of the amplitude of the vibration due to the reduction of the pulse voltage applied to the shape-memory alloy can be controlled. The micro wire is a wire made of metal material which has at least relatively small liner resistance and specific resistance and which does not generate a motion of expansion and contraction by applying the pulse voltage. This micro wire can also be made up of a clear electrode.

In the tactile perceptual unit, the micro wire is gripped by the transparent plate and the transparent protective cover, so that an adhesion of a dust to the hole can be prevented.

It is preferable to use a film-shaped deformable material for the transparent protective cover, because user touches the shape-memory alloy and the touch switch through the transparent protective cover.

The micro wire is fixed with the transparent protective cover, because the transparent protective cover has a hole which has the same as that of the hole of the transparent plate in a corresponding position and thereby the shape-memory alloy is exposed at the hole of the transparent protective cover. The living being such as a finger can receive the information of the tactile sense, because the living being directly can touch the shape-memory alloy and the touch switch.

A metal wire made of gold, silver, copper, aluminum, or tungsten is used for the micro wire, and also the micro wire and the shape-memory alloy are connected by welding at both edges of the hole respectively. Therefore, the resistance in a region which is not vibrated can be made a low value and the welded connection can tolerate the vibration, and thereby a highly stabilized device can be achieved.

Welding connection of the shape-memory alloy and the micro wire can be achieved while minimizing an obstruction of a view of the display panel because the overlapping region of the welded connection is adjusted within a range from 0.2 mm to 0.4 mm.

The user can recognize an accomplishment of a touch input to the touch panel by means of the click-like feeling or the sense of touch varied by the touched position, because the information of the touch input is transmitted to the tactile sense of the living being in response to the input motion to the touch panel.

A vibration of the piece of the transparent plate in accordance with the motion of expansion and contraction of the shape-memory alloy can give to the living being the click-like feeling as pressing the button switch at the time of the touch input to the touch switch.

### BRIEF DESCRIPTION OF THE DRAWINGS

FIG. 1 (A) is a block diagram of the device for transmitting information to the living being according to a first embodiment of the present invention. FIG. 1 (b) is an exploded perspective view of a unit for transmitting a tactile sense in the device for transmitting information.

FIG. 2 (A) is a top view showing an example of the unit for transmitting the tactile sense in the device for transmitting information. FIG. 2 (B) is a top view showing another example of the unit for transmitting the tactile sense.

FIG. 3 is a characteristic diagram of a shape-memory alloy in the device for transmitting information.

FIGS. 4 (A) to 4 (E) are views showing conditions of application for applying pulse-waves to the shape-memory alloy.

FIGS. 5 (A) to 5 (D) are views showing conditions of application for applying simultaneously the stimulus of the pulse-waves.

FIGS. 6 (A) to 6 (D) are views showing conditions of application for applying the pulse-waves having an identical amplitude value.

FIG. 7 (A) is a perspective view of the first modification of the device for transmitting information in which a portion in the shape-memory alloy in which the living being does not touch the shape-memory alloy is replaced to the micro wire, and FIG. 7 (B) is a perspective view of another modification of the device in which a portion in the shape-memory alloy in which the living being does not touch the shape-memory alloy is replaced to a transparent electrode.

FIG. 8 is a perspective view of the device for transmitting information according to a second modification.

FIG. 9 is a sectional view of the device for transmitting information according to a third modification.

FIG. 10 is a block diagram of the device for transmitting information to the living being according to the second embodiment of the present invention.

FIG. 11 (A) is a top view showing an example of a touch panel in the device for transmitting information, and FIG. 11 (B) is a top view showing another example of the touch panel in the device for transmitting information.

FIG. 12 is a block diagram showing another example of the unit for transmitting the tactile sense which is arranged on the touch panel in the device for transmitting information.

### DESCRIPTION OF THE PREFERRED EMBODIMENTS

### First Embodiment

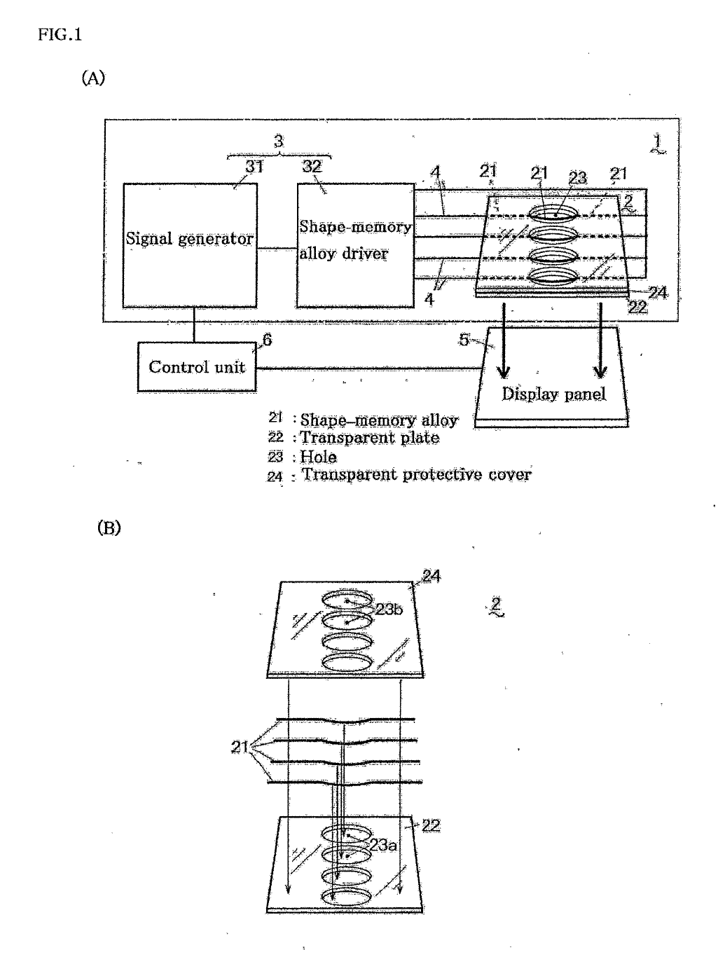

A device for transmitting information according to a first embodiment of the present invention is described with reference to FIG. 1. An information transmitting device 1 (herein referred to as “device 1”) to a living being includes a tactile perceptual unit 2 and a signal generating unit 3 (which acts as a signal generator), wherein the tactile perceptual unit 2 is a transparent plate having a shape-memory alloy 21 arranged for being touched by the living being at a time of a touch input, and wherein the signal generating unit 3 generates the signal (signal voltage) for driving the tactile perceptual unit 2.

The tactile perceptual unit 2 is arranged on the display panel 5 which displays a screen image, an illustration, or the like. The signal generating unit 3 includes a signal generator 31 and a shape memory driver 32, wherein the signal generator 31 generates a signal to drive the tactile perceptual unit 2, and the driver 32 generates a pulse-wave for driving the shape-memory alloy 21 of the unit 2 in response to the signal from the signal generator 31.

The display panel 5 is a graphic display device for displaying a screen image in response to received signal or an object which displays illustration(s), symbol(s), or the like. In case that the display panel 5 is the graphic display device, the device 1 includes a control unit 6 to generate the signal for displaying the screen image. This control unit 6 outputs the signal which is associated with the image data displayed on the display panel 5 to the signal generator 31. Thereby, the signal generator 31 generates the signal for driving the tactile perceptual unit 2 to transmit the information associated with the screen image to the living being. In case that the display panel 5 is the object which displays the illustration, the signal generator 31 generates the data associated with the object. In this case, the control unit 6 is not necessarily required.

The tactile perceptual unit 2 includes a shape-memory alloy 21, a transparent plate 22, and a transparent protective cover 24 covering the shape-memory alloy 21 and the transparent plate 22, wherein the shape-memory alloy 21 has a form of a thin wire, and the shape-memory alloy 21 provides a vibrational motion generated by an expansion and contraction thereof. The shape-memory alloy 21 is attached to an upper surface of the transparent plate 22.

The transparent plate 22 has a hole 23a arranged on a plate surface, wherein the shape-memory alloy 21 is attached to the transparent plate 22 so as to be suspended across the hole 23a, and both ends of the shape-memory alloy 21 extend to side edges of the transparent plate 22, and then the both side edges of the shape-memory alloy 21 are connected to a micro wire 4 as a lead wire which transmits the signal from the signal generating unit 3 to the shape-memory alloy 21.

The portion of the shape-memory alloy 21, which is suspended across the hole 23a, is fixed to the transparent plate 22 by both edges of the hole 23a at a relaxed state when the signal voltage is not applied to this alloy. The shape-memory alloy 21 is arranged on condition that a tension occurs in the shape-memory alloy 21 when the shape-memory alloy 21 is pressed by the living being, and, the loose level of the shape-memory alloy 21 is adjusted enough to be able to touch the finger tip of the living being to the touch panel positioned below the hole 23a.

When a signal voltage is applied to the shape-memory alloy from the signal generating unit 3, the shape-memory alloy is contracted in response to this signal voltage. Thereby, the information of the tactile sense can be transmitted to the living being in contact with this alloy.

In the present embodiment, the transparent protective cover 24 has a hole 23b at a position corresponding to the hole 23a of the transparent plate 22. Both the hole 23a and the hole 23b, hereinafter, are referred to as the hole 23. If thin and flexible film material is employed as the transparent protective cover 24, the hole 23b can be omitted. In the above case, the living being touches the shape-memory alloy 21 and the touch panel or the like through the transparent protective cover 24, so that a sensitivity of the tactile sense of the living being becomes low. However, an adhesion of a dust, a rubbish, or the like to the hole 23 can be prevented by providing the transparent protective cover 24 on a surface of the hole 23.

The shape-memory alloy 21 consists of a thin wire having a diameter of 50 μm or less. A clear glass, a transparent resin, or the like can be used for the transparent plate 22. Also, the clear glass, the transparent resin or the like can be used for the transparent protective cover 24. It is preferable that the transparent protective cover 24 is formed as thin as possible, so that it is preferable that the transparent resin which can be formed into a film shape is used. In FIG. 1, the four pairs of the shape-memory alloy 21 and the hole 23 are illustrated, however, more pairs of the shape-memory alloy 21 and the hole 23 can be arranged in matrix form on a surface of the transparent plate 22.

The signal generator 31 receives the data from the control unit 6 when the device 1 has the control unit 6 as mentioned above, and an information corresponding to the illustration or the like displayed on the display panel 5 is stored in the signal generator 31 when the device 1 does not have the control unit 6. The shape memory alloy driver 32 outputs pulse waves for driving the shape-memory alloy 21 to the shape-memory alloy 21 via the micro wire 4.

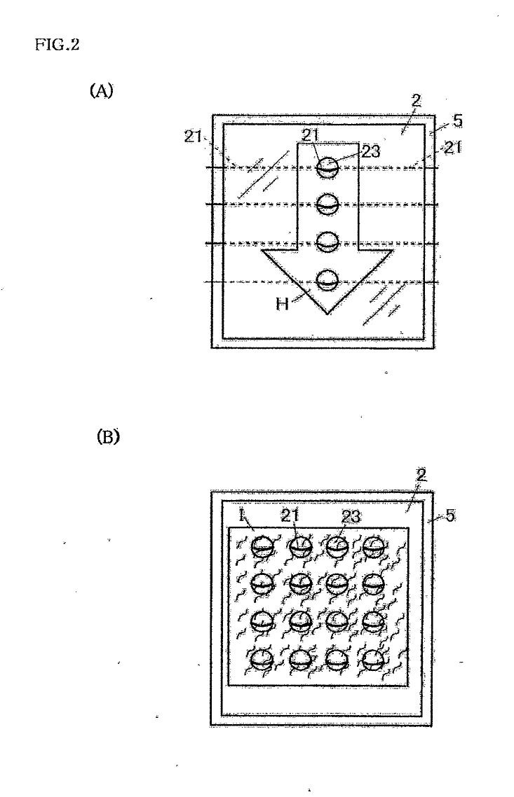

FIGS. 2 (A) and 2 (B) show examples of the tactile perceptual unit 2 arranged on the display panel 5.

In FIG. 2 (A), the display panel 5 is an object displaying an arrow or the like. Also, for example, the four holes 23 and four shape-memory alloys 21 are arranged on an illustration of an arrow H, respectively. The user can clearly and visually recognize the illustration of the arrow H by motion of the tactile perceptual unit 2. In present embodiment, the four pairs of the shape-memory alloy 21 and the hole 23 are arranged on the illustration of the arrow H. The signal generator 31 outputs the signal which gives the living being the tactile sense which indicates that a material moves toward the same direction indicated by the illustration of the arrow H to a shape-memory alloy driver 32 (abbreviated as “the driver”), from the information of the arrow H stored in the signal generator 31. The driver 32 then outputs the pulse-wave to drive the shape-memory alloy 21 based on the signal from the signal generator 31. In this embodiment, when the pulse-wave is applied in order, from an upper side position to a lower side position of the tactile perceptual unit 2 as shown in FIG. 2 (A) on condition that the user puts his hand or fingertip on the shape-memory alloy 21 of the four sets of the tactile perceptual unit 2 so as to touch and cover the four sets of the tactile perceptual unit 2, the user can perceive the tactile sense as if the material moves in the same direction as that of the arrow H, and thereby the user can perceive the direction of the arrow H by the information of the tactile sense.

In FIG. 2 (B), the display panel 5 is the graphic display device, wherein two or more pairs of the shape-memory alloy 21 and hole 23 are arranged on the graphic display device in matrix form. The lead wires for driving the shape-memory alloy 21 are omitted in this figure, however, for example, several sets of tactile perceptual unit 2, as shown in FIG. 1 (A), can be used. For example, there are four sets of tactile perceptual unit 2 in the same line in FIG. 2 (B), so that a total number of the micro wires 4, which are connected to the driver of the shape-memory alloy, is four respectively at the both ends. If the gold wire having a diameter of 25 μm is used as the micro wire 4, for example, the display of the display panel 5 is obstructed by the micro wires 4 having the line width of approximately 100 μm. However, actual visibility of the display panel will hardly be affected. For example, a cloth I is displayed on the display panel 5 by the control unit 6. The user can see an image of the cloth I by motion of the tactile perceptual unit 2. The control unit 6 outputs the signal associated with image data of the cloth I to the signal generator 31. The signal generator 31 outputs the signal for giving the living being the tactile feeling of the cloth I based on the signal from the control unit 6 to the driver 32. The driver 32 outputs the pulse-wave which makes the shape-memory alloy 21 drive based on the signal from the signal generator 31. In this case, if the pulse wave, which is mentioned below, is applied to the shape-memory alloy 21, the user can perceive the tactile sense of the cloth I which is currently displayed by touching the tactile perceptual unit 2. Thus, by transmitting the information of the visual image and the tactile sense of the object being displayed on the display panel 5, the tactile sense of the object can remotely be transmitted to the user.

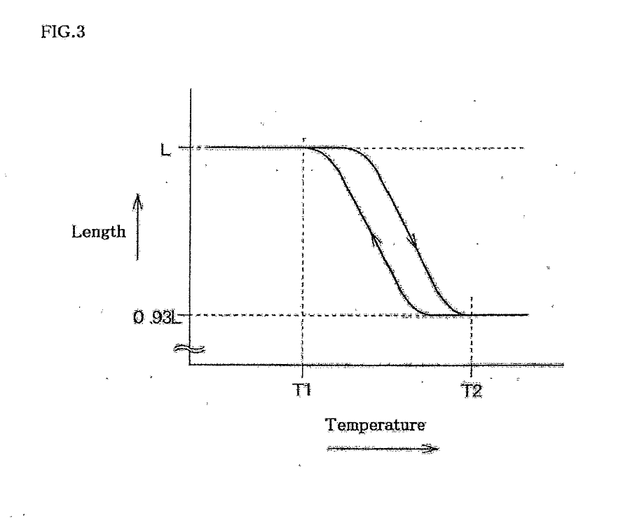

Next, an operating principle of the shape-memory alloy 21 is described with reference to FIG. 3, in case that the pulse-wave is applied. FIG. 3 shows a relationship between a temperature and a length of the shape-memory alloy 21. A horizontal axis shows the temperature of the shape-memory alloy 21, and a vertical axis shows the length of the shape-memory alloy 21. The shape-memory alloy 21, which has resistance, generates heat during applying the pulse-wave. In addition, the shape-memory alloy 21 is contracted by 7% when the temperature is T2 or more, and thereby the length of the shape-memory alloy 21 is changed from its original length L to 0.93 L in length. The shape-memory alloy 21 radiates the heat the pulse-wave is not applied, and then the length of the shape-memory alloy 21 returns to its original length L when it is cooled to a temperature T1 or less. Then the length of the shape-memory alloy 21 repeats change to the length L and the length 0.93 L while the heating the shape-memory alloy 21 to the temperature T2 or more and cooling it to the temperature T1 or less is repeated by the cyclic application of the pulse-wave, and thereby the shape-memory alloy 21 vibrates. Therefore, when the shape-memory alloy 21 is vibrated while supplying a tension to the shape-memory alloy 21 by pressing the living being such as the finger, for example, on the shape-memory alloy 21 suspended across the hole 23a, the information can be transmitted to the living being by means of the vibration.

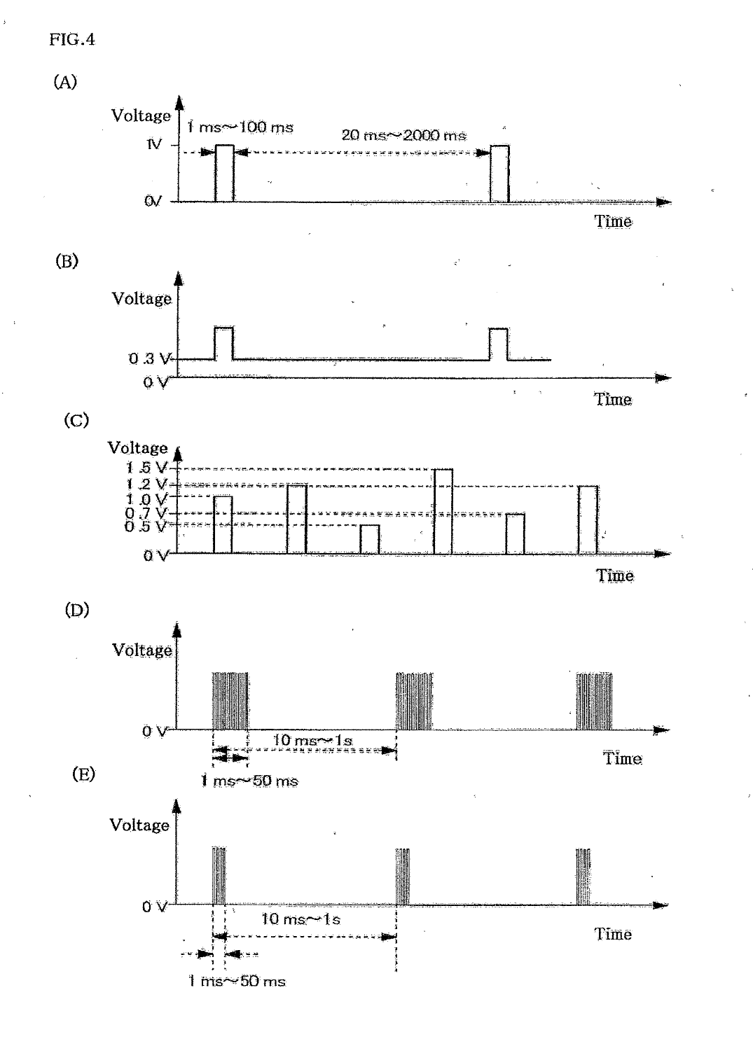

Next, a method for applying the pulse-wave for vibrating the tactile perceptual unit 2 is described with reference to FIG. 4. In this case, the shape-memory alloy 21 suspended across the hole 23 has, for example, a diameter of 50 μm, a length of 5 mm, and a resistance of 5 Ω. FIGS. 4 (A) to 4 (E) show states of applying the pulse-wave. A horizontal axis shows time and a vertical axis shows voltage. FIG. 4 (A) shows a time ratio of ON state and the OFF state of the pulse-wave. The shape-memory alloy 21 needs time to cool it down for re-heating, because the shape-memory alloy 21 cannot be contracted by re-heating again unless it radiates the heat and cools down once it is heated and contracted. An effective duty ratio of a time for applying the voltage of heating the shape-memory alloy 21 and the other time, in which the voltage is not applied, for cooling down the shape-memory alloy 21, is approximately 1:20. The shape-memory alloy 21 does not vibrate due to insufficient cooling down, when the other time, in which the voltage is not applied, is shortened. If a time for applying the voltage is set to 1 to 100 ms, the time, in which the voltage is not applied, is set to 20 to 2000 ms.

FIG. 4 (B) shows a method for applying the voltage when the shape-memory alloy 21 is pre-heated. The shape-memory alloy 21 is pre-heated when the voltage of 0.3V is applied as offset voltage, and thereby the shape-memory alloy 21 can be vibrated by the pulse-wave with a voltage of relatively low peak value.

FIG. 4 (C) shows a method for applying the voltage when the peak value of the pulse-wave is changed. The peak value is changed to 1V, 1.2V, 0.5V, 1.5V, 0.7V, and 1.2V. As the peak value is lowered, the shape-memory alloy 21 vibrates weakly, and as the peak value is increased, the shape-memory alloy 21 vibrates more strongly. By changing the magnitude of the peak value, the strength of vibration of the shape-memory alloy 21 can be adjusted.

FIG. 4 (D) shows a method for applying the voltage to vary an interval of applying the pulse-wave under a constant duration of applying the pulse-wave, when the pulse-wave is discretely applied. The duration of applying the pulse-wave is set to a constant time between 10 ms to 500 ms, and the interval of applying the pulse-wave is varied from 10 ms to 1 sec. As the interval is shortened, the stimulus, which is given to the living being, gets stronger, and as the interval is lengthened, the stimulus, which is given to the living being, gets weaker. The stimulus, which is given to the living being, can be adjusted by varying the interval of applying the pulse-wave.

FIG. 4 (E) shows a method for applying the voltage to vary the duration of applying the pulse-wave under a constant interval of applying the pulse-wave, when the pulse-wave is discretely applied. The constant interval of applying the pulse-wave is set to 10 ms to 1 sec, and the duration of applying the pulse-wave is varied from 1 ms to 50 ms. As the duration is lengthened, the stimulus, which is given to the living being, gets stronger, and as the duration is shortened, the stimulus, which is given to the living being, gets weaker. The stimulus, which is given to the living being, can be adjusted by varying the duration of applying the pulse-wave.

The device 1 according to this embodiment is small in size and lightweight, has a good energy efficiency, can be used for high frequency operation, and has high resolving of a vibrating source. In addition, if the vibration of approximately 0.5 Hz is generated at a whole of the device, the generated vibration can transmit the tactile sense such as a pulse of a human or click-like feeling at a time when a switch to the living being is pressed. Also, if the device 1 is driven at a frequency of 10 to 200 Hz, the generated vibration can transmit the tactile sense of vibrating motion to the living being.

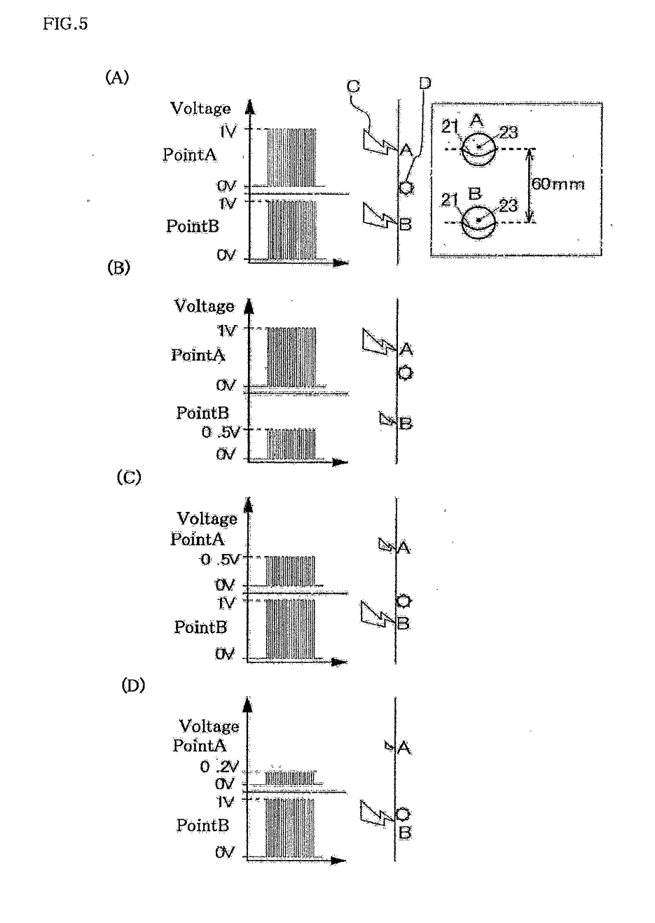

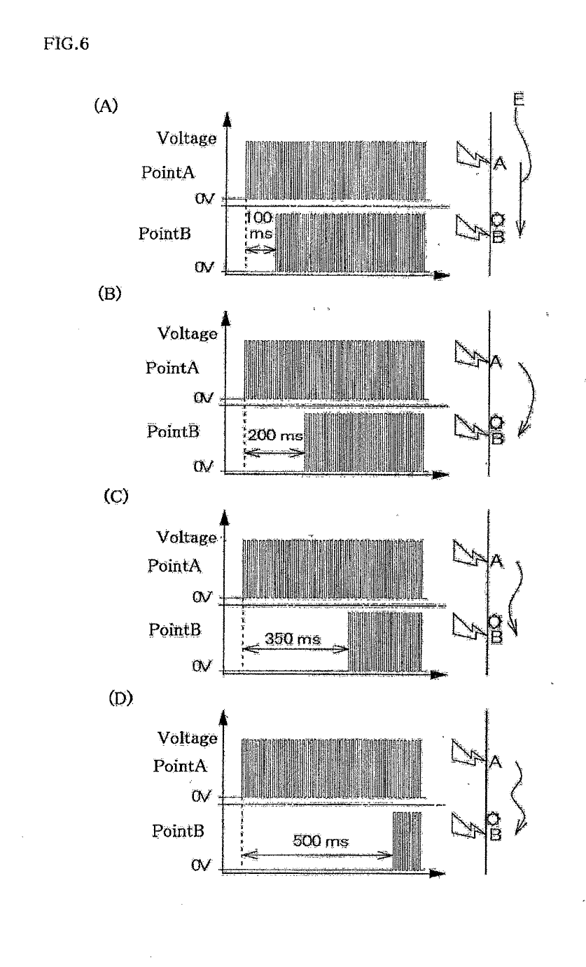

Next, the method for giving the living being an information of a position of a vibration source and a movement of the object, by using the device 1 according to this embodiment, is described with reference to FIGS. 5 and 6. FIGS. 5 (A) to 5 (D) show that the information of the position of the vibration source can be transmitted to the living being which is connected to both of two points (point A, point B) of the shape-memory alloy 21, by applying the driving pulse having different peak values. In FIGS. 5 (A) to 5 (D), the plane view of the point A and the point B is illustrated within a frame drawn by the alternate long and short dash line. The tactile sense transmitted to the living being is illustrated when, for example, the hand of the living being is pressed against the shape-memory alloy 21, wherein the tactile sense is generated by two of the shape-memory alloy 21, each of which is suspended across the hole 23 arranged at one of two positions (point A, point B), which are 60 cm apart. A horizontal axis shows time and a vertical axis shows the peak value of the pulse-wave applied to the shape-memory alloy line 21 corresponding to the point A and the point B. In addition, the mark of the stimulus C shows intensities of the stimulus given to the living being at the point A and the point B, and the mark of the recognition position D shows the positions where the living being feels the stimulus, respectively. The size of the mark of the stimulus C expresses the intensity of the stimulus, and the position of the mark of the recognition position D shows a position between the point A and the point B where the living being feels the vibration source.

In FIG. 5 (A), the living being recognizes that the vibration source is positioned at a middle point between the point A and the point B, because the peak value of the pulse-wave of the point A and the point B is the same 1V. In FIG. 5 (B), the living being recognizes that the vibration source is positioned nearer the point A, because the peak value of the point A is 1V and that of the point B is 0.5 V. In FIG. 5 (C), the living being recognizes that the vibration source is positioned nearer the point B, because the peak value of the point A is 0.5 V and that of the point B is 1 V. In FIG. 5 (D), the living being recognizes that the vibration source is positioned even nearer the point B compared to the case of FIG. 5 (C), because the peak value of the point A is 0.2 V and that of the point B is 1 V. As described above, the device 1 can generate a phantom sensation which, as it were, gives the living being the tactile sense recognizing that the vibration source is existing at an unreal position.

FIGS. 6 (A) to 6 (D) show that an information of the tactile sense expressing that the object is moving between the two points (point A, point B) can be transmitted to the living being by applying two driving pulse-waves to the two shape-memory alloys 21 (point A, point B) at the different time. In FIGS. 6 (A) to 6 (D), the sense of move indicated by a mark E shows the tactile feeling depending upon the travel speed of the vibration source. As to the sense of move indicated by the mark E, an undulating curve of the mark E expresses a feeling, which is felt by the living being of the travel speed of the vibration source. An increase of a total number of waves of the undulating curve indicates that the travel speed is felt slower. As for FIG. 6 (A) to FIG. 6 (D), both of the peak values of the pulse-waves of the point A and the point B shows 1 V, however, the time differences between a start time for applying the pulse voltage at the point A and a start time for applying the pulse voltage at the point B are different, i.e. the time differences are 100 ms, 200 ms, 350 ms and 500 ms in FIGS. 6 (A) to 6 (D), respectively. Also, under condition as shown in FIG. 6(A), the living being feels the tactile sense as if the vibration source moves quickly from the point A to the point B. Also, in accordance with an increase of the time differences between the start time for applying the pulse voltage at the point A and the start time for applying the pulse voltage at the point B, the living being can feel an unreal movement as if the vibration source moves slowly from the point A to the point B. In addition, according to the above configuration, an advanced tactile sense such as a smooth feeling, a prick pain feeling, or a rough feeling can be given to the living being.

By the above unreal movement, the information relating to the display can be transmitted to the tactile sense of the living being which contacts the shape-memory alloy 21 of the tactile perceptual unit 2 arranged on the display panel 5. Thus, as described above, the information of the tactile sense of the object or the like which is a screen image displayed on the display screen can be transmitted to the living being. In addition, the wire diameter of the shape-memory alloy 21 is made small, and the transparent plate 22 and the transparent protective cover 24 is transparent, so that the screen image can be visually confirmed without obstructing the view of the display panel 5.

### (The First Modification of a First Embodiment)

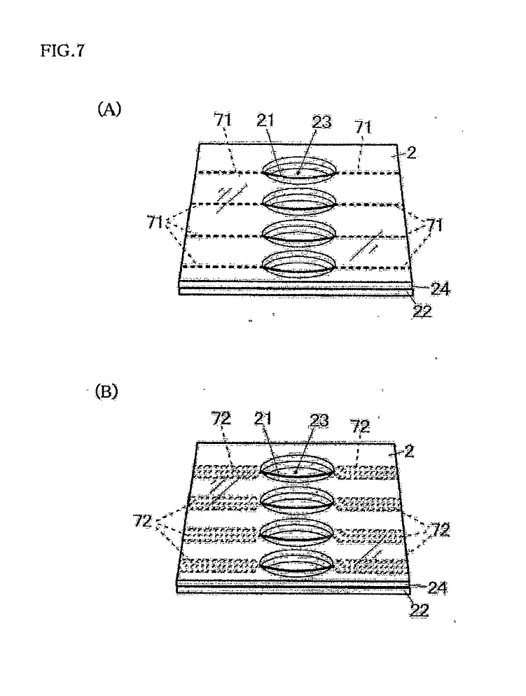

Next, with reference to FIG. 7, the first modification of this embodiment is described. In the present modification, a portion of the shape-memory alloy 21, which does not contact the living being, is replaced to other material. FIG. 7 (A) shows an example that the portion is replaced by a micro wire 71. The micro wire 71 is the metal wire such as gold, silver, copper, aluminum, and tungsten, or the like having a diameter any one of 10-50 μm. As a method for connecting the micro wire 71 with the shape-memory alloy 21, a supersonic wave, welding, or the like is included, and the material suitable for each connecting method is chosen. The field of view of the display panel is more improved, because the diameter of the micro wire 71 is equal to or smaller than that of the shape-memory alloy 21.

FIG. 7 (B) shows an example that the portion is replaced a clear electrode 72. Also in this case, the field of view of the display panel is even more improved, because the clear electrode 72 is transparent.

These micro wires 71 can make the driving voltage low, due to the generally lower resistance in comparison with the shape-memory alloy 21, and thereby the tactile perceptual unit 2 easier can be easily manufactured and also, energy saving can be achieved. In addition, the device 1 can be battery-operated, so that it can be portable. As described above, it is effective that only the portion contacted by the living being is made of the shape-memory alloy 21 and the other portion which is not contacted by the living being is made of the micro wire 71, then a resistance of the whole device can be made lower. Therefore, the device can be driven by a low voltage and a low power consumption is achieved. Furthermore, the use of the shape-memory alloy only in the portion which is vibrated by an expansion and contraction can transmit the vibration effectively to the living being which contacts the shape-memory alloy 21. In addition, a welding using the laser is the most preferable to connect the shape-memory alloy 21 and the micro wire 71. In case that, for example, solder joint is used for this connection, the solder deforms into tunnel shape covering the shape-memory alloy, and thereby the solder connection becomes high resistance, and then the solder connection is removed and it becomes impossible to use it, because the shape-memory alloy is itself contracted and thickened by heat by applying the pulse voltage, and also the shape-memory alloy is expanded and thinned in accordance with a heat radiation. In addition, it is difficult to connect the lines of the shape-memory alloy with the super-thin micro wire by the solder, because the contact areas are small.

In contrast, the welding manufactures an alloy by melting the materials to be connected. In this case, the ends of the shape-memory alloy 21 and the micro wire 71 are overlapped, and the overlapped region is set from 0.2 mm to 0.4 mm. Accordingly, the welding can be performed while minimizing a loss of the visibility over the display panel. In addition, as the materials with different melt temperatures are melted at the same time, the best condition of a laser radiation is required in consideration of the element and mass of materials or the like.

### (The Second Modification of a First Embodiment)

Next, with reference to FIG. 8, the second modification of this embodiment is described. In this modification, the shape-memory alloy 21 is sandwiched between the transparent plate 22 and the transparent protective cover 24 at the relaxed state. The shape-memory alloy 21 is fit on movably in radial direction of the hole 23 at a position of both edges of the hole 23. If the shape-memory alloy 21 of the hole 23 is pressed by a finger Y, the whole shape-memory alloy 21 is stretched, and when the pulse-wave is applied, the shape-memory alloy 21 is vibrated, and thereby information is transmitted to the finger Y. There is no need to secure the shape-memory alloy 21 to the transparent plate 22, so that an assembling of the tactile perceptual unit 2 becomes easier.

### (The Third Modification of a First Embodiment)

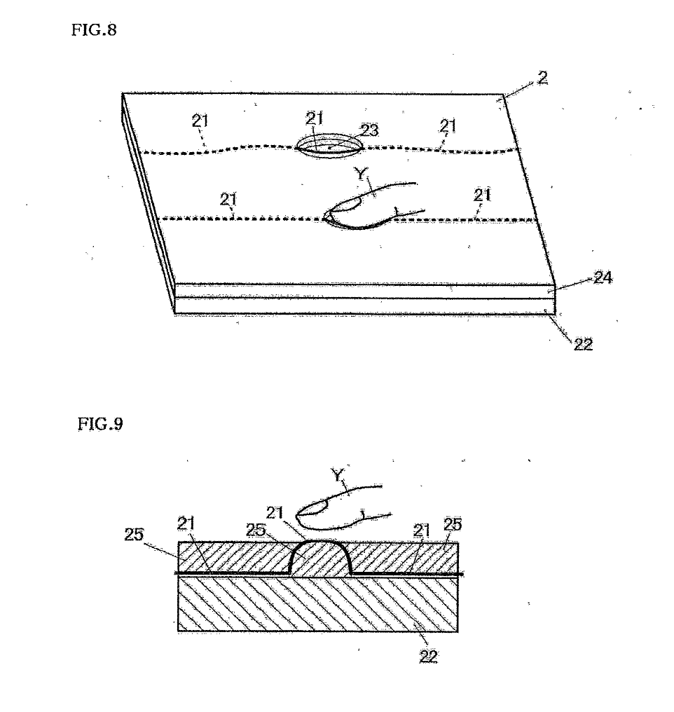

Next, with reference to FIG. 9, the third modification of this embodiment is described. In this modification, the shape-memory alloy 21 is bent into a horseshoe-shape, and the horseshoe-shape, which is arranged perpendicularly to the transparent plat 22, is fixed to the transparent plate 22 at a root of the horseshoe-shape. The transparent plate 22 does not need to have the hole. The shape-memory alloy 21 is covered with the transparent resin film 25 which has elasticity, and the top portion of the horseshoe-shape of the shape-memory alloy 21 is exposed on the resin 25. Also, an inner portion of the horseshoe-shaped is filled with the resin 25. When the electric current is applied to the shape-memory alloy 21, the shape-memory alloy 21 is heated and contracted, and then the top is pressed down by stretching the resin 25. When the electric current is stopped, the shape-memory alloy 21 is cooled down and then returns to its original length, and the top portion is raised by the elasticity of the resin 25. By power-on and power-off of the current, the top is pressed down and raised up repeatedly and thereby the shape-memory alloy 21 is vibrated. According to the above configuration, the shape-memory alloy 21 to which tensile force is applied, is vibrated, so that strong stimulus can be provided to the living being touching the shape-memory alloy 21. In addition, the resin 25 covers the top of the horseshoe-shape unless the vibration of the shape-memory alloy 21 is disturbed.

### Second Embodiment

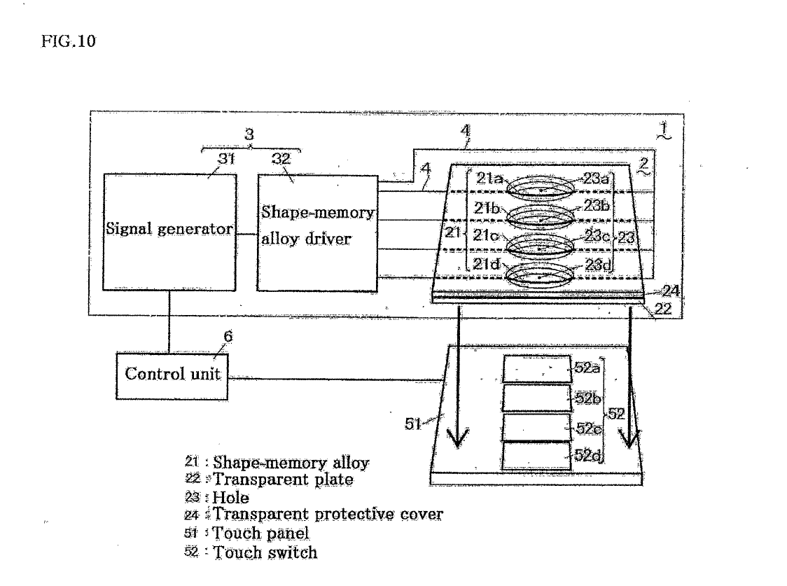

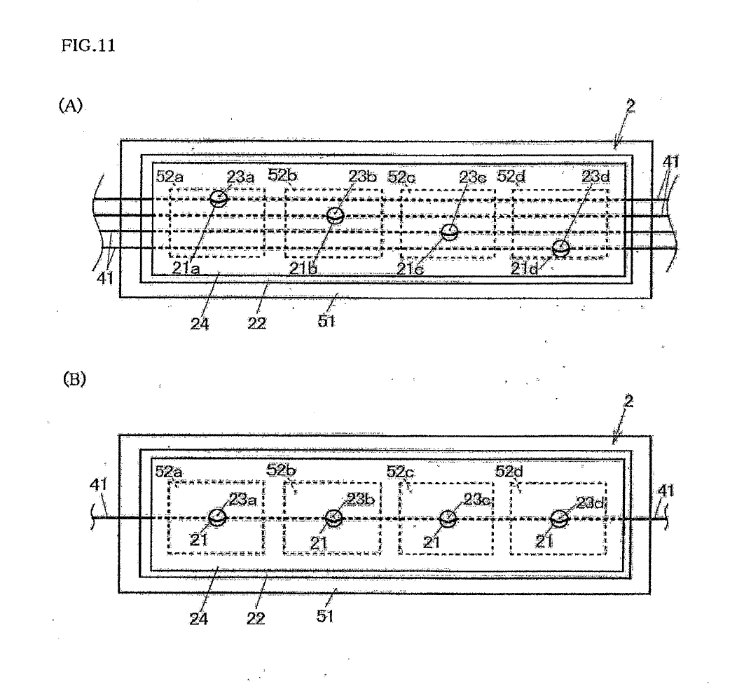

Next, with reference to FIG. 10, the device for transmitting information according to the second embodiment of the present invention is described. In this embodiment, the display panel is a touch panel 51 and the tactile perceptual unit 2 transmits the information to the living being in response to a touch input to the touch panel 51. The touch panel 51 has touch switches 52a, 52b, 52c, and 52d (collectively called the touch switch 52), and the tactile perceptual unit 2 is arranged so that the holes 23a, 23b, 23c, and 23d are located on corresponding positions of the touch switches 52, respectively. The shape-memory alloys 21 (21a, 21b, 21c, and 21d) are located in these holes 23. When the user, for example, presses the touch switch 52a with the finger via the hole 23a, the signal outputted from the touch switch 52a is sent to the control unit 6, and the control unit 6 outputs data indicating that the touch switch 52a is pressed into the signal generator 31. In response to the data from the control unit 6, the signal generator 31 vibrates the shape-memory alloy 21a suspended across the hole 23a via the shape-memory alloy driver 32. Accordingly, the user who presses the touch switch 52a feels the vibration of the shape-memory alloy 21 on the fingertip, and can feel the click-like feeling.

At this time, the vibration patterns such as the number of vibration of the shape-memory alloy 21, vibration periods, or the like may be changed by each touch switch 52. In this case, the touch switch which is pressed can be recognized by the vibration pattern of the shape-memory alloy 21, so that the user can perform the operation without a visual confirmation of the touch panel 51. The above configuration is effective in the console panel of a car or the like.

Next, with reference to FIGS. 11 (A) and 11 (B), the other examples of an arrangement of the shape-memory alloy in the touch panel 51 is described. In FIG. 11 (A), the touch panel 51 has touch switches 52a to 52d, and sets of one of the holes 23a to 23d and one of the shape-memory alloys 21a to 21d are respectively arranged on the touch switches 52a to 52d. Several shape-memory alloys 21, which are arranged in the hole 23 of other touch switches, are passed on each touch switch. Even if several shape-memory alloys 21 pass on each touch switch as described above, there is no problem in any case, and thereby the wiring design becomes easy. Also, in this case, although the four micro wires are lined on each touch switch, a visibility is hardly affected when a micro wire having a diameter of approximately 25 micrometer is used.

In FIG. 11 (B), each shape-memory alloy 21 of the holes 23a to 23d arranged on the touch switch 52a to 52d is connected each other in series by a micro wire. When any one of the touch switches 52 is pressed, all of the shape-memory alloys 21 in the holes 23a to 23d vibrate and transmit the response to the user. Even if several shape-memory alloys 21 are used, the number of micro wires can be reduced, so that the cost can become low.

### (Modification of a Second Embodiment)

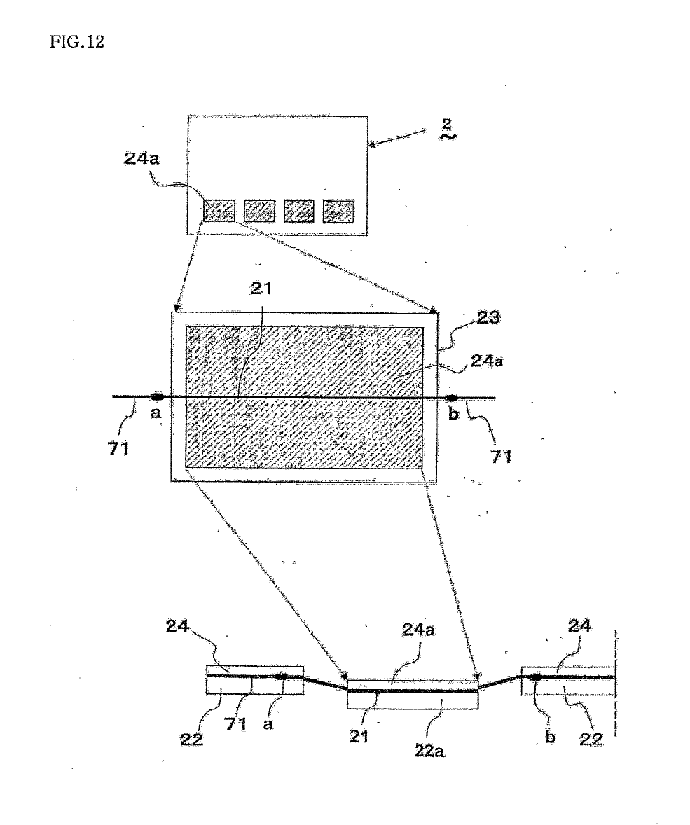

Next, with reference to FIG. 12, the modification of the second embodiment is described. The tactile perceptual unit 2 in this modification has a configuration that transparent plate pieces 22a, and 24a having the shape similar to the holes 23, wherein the pieces 22a and 24a are attached to each hole 23 in both of the transparent plate 22 and the transparent protective cover 24. The transparent plate pieces 22a and 24a are bonded together in condition that an upper side and lower side of the shape-memory alloy 21 crossing the holes 23 is sandwiched between the pieces 22a and 24a. Points “a” and “b” indicate the welded points between the shape-memory alloy 21 and the micro wire 71. According to the above configuration, a vibration of the shape-memory alloy 21 is directly transmitted to the transparent plate pieces 22a and 24a, and thereby the amplitude of the vibration is amplified and transmitted to the fingertip. The tactile perceptual unit 2, for example, is arranged on the screen of the touch panel display of a car navigation. When the user, for example, presses down the touch switch (for example, the touch switch 52a in FIG. 10) by the finger from the hole 23, a signal from the touch switch is sent to the control unit 6 (refer to FIG. 10), and the control unit 6 outputs the data that the touch switch is pressed to the signal generator 31. The signal generator 31 vibrates the shape-memory alloy 21 which is suspended across the hole 23 via the driver 32 based on the data from the control unit 6. By transmitting the vibration to the transparent plate pieces 22a and 24a, the user who presses down the touch switch can feel the force of a virtual button at the fingertip. The above configuration provides a feeling as if the actual button is pressed.

Also, the present invention is not restricted by a configuration as described above, so various modification of the embodiment can be conceived without deviation from a scope of the invention. For example, the condition of applying the pulse-wave can be adjusted so that the shape-memory alloy 21 vibrates. In addition, the embodiment can be assembled by combining arbitrary contents of the embodiments described above. As to the shape-memory alloy and the micro wire, the wire having a diameter of 10-200 μm can be used. From a mechanical strength and an ability of transmitting the tactile sense of view, the diameter of 30-150 μm is preferable.

### DESCRIPTION OF THE REFERENCE NUMERALS

1 information transmitting device
2 tactile perceptual unit
21 shape-memory alloy
22 transparent sheet
23 hole
3 signal generating unit (signal generator)
4,71 micro wire
5 display panel
51 touch panel

1. A device for transmitting information, which device transmits an information of tactile sense to a living being touching a shape-memory alloy, by motion of expansion and contraction of the shape-memory alloy generated by applying voltage to the shape-memory alloy,
the device comprising:
a tactile perceptual unit arranged on a display panel which displays visual information, and
a signal generating unit which generates a signal voltage for driving the tactile perceptual unit, wherein:
the tactile perceptual unit has a transparent plate arranged on a part of a surface of the display panel and the shape-memory alloy attached to the transparent plate,
the shape-memory alloy, having a thin wire-like form, is in a relaxed state at a time that the signal voltage is not applied and is touchable by the living being through a protective cover or not, and transmits the information of the tactile sense to the living being touching the shape-memory alloy through the protective cover or not, by contracting the shape-memory alloy in response to an application of the signal voltage from the signal generating unit to the shape-memory alloy, and
the signal generating unit generates the signal voltage related to the displaying image on the display panel.

2. The device according to claim 1, wherein the shape-memory alloy is used in a portion touched by the living being and, in the other portion, a micro wire is substituted for the shape-memory alloy.

3. The device according to claim 2, wherein the transparent plate of the unit for transmitting the tactile sense has a hole in a predetermined position,
the shape-memory alloy is arranged so that the shape-memory alloy is suspended across the hole of the transparent plate in the relaxed state,
both ends of the shape-memory alloy are connected to the micro wire, and
each micro wire is extended to both ends of the transparent plate, and connected to the signal generating unit at both ends.

4. The device according to claim 3, wherein the holes of the transparent plate are arranged in series, and the ends of the shape-memory alloy, which is suspended across the hole, are connected to the micro wire,
a plurality of the shape-memory alloys are connected in series by the micro wire.

5. The device according to claim 3, in case that the tactile perceptual unit has a protective cover, the protective cover is transparent and covers both the shape-memory alloy and the micro wire so as to sandwich the shape-memory alloy and the micro wire between the transparent plate and the transparent protective cover.

6. The device according to claim 5, wherein the transparent protective cover has the hole having the same shape in a position corresponding to the hole of the transparent plate, and the hole exposes the shape-memory alloy.

7. The device according to claim 3, wherein the micro wire is a metal line made of gold, silver, copper, aluminum or tungsten, and each micro wire is connected to the shape-memory alloy by welding at both edges of the hole respectively.

8. The device according to claim 7, wherein the overlap region between the shape-memory alloy and the micro wire, connected by welding, is set within a range from 0.2 mm to 0.4 mm.

9. The device according to claim 3, wherein when the display panel is a touch panel having a touch switch,
the signal generating unit drives the tactile perceptual unit, in response to an input motion by the living being touching to the tactile perceptual unit which is arranged on the touch switch.

10. The device according to claim 9, wherein a piece of transparent plate with a shape smaller than the hole is fixed to a part of the shape-memory alloy suspended across the hole of the transparent plate.
